(19) United States
(12) Patent Application Publication
(10) Pub. No.: US 2010/0220653 A1
(43) Pub. Date: Sep. 2, 2010

(54) MULTI-PATH ROUTING METHOD IN WIRELESS SENSOR NETWORK

(76) Inventors: So-Young Hwang, Busan-city (KR); Bong-Soo Kim, Daejeon-city (KR); Cheol-Sig Pyo, Daejeon-city (KR); Jong-Suk Chae, Daejeon-city (KR); Moon-Seong Kim, Gyeonggi-do (KR); Eui-Hoon Jeong, Gyeonggi-do (KR); Young-Cheol Bang, Gyeonggi-do (KR)

Correspondence Address: LADAS & PARRY LLP, 224 SOUTH MICHIGAN AVENUE, SUITE 1600, CHICAGO, IL, 60604, US

(21) Appl. No.: 12/682,920

(22) PCT Filed: Jul. 30, 2008
(86) PCT No.: PCT/KR2008/004430

§ 371 Date: Apr. 14, 2010

(30) Foreign Application Priority Data
Nov. 1, 2007 (KR) 10-2007-0111015

(51) Int. Cl. H04W 4/00

(52) U.S. Cl. 370/328

(57) ABSTRACT

A multi-path routing method is provided a multi-path routing method for selecting appropriate multiple paths when information sensed from a source node is transmitted to a sink node in wireless sensor networks. The source node for transmitting the sensed information first transmits a Hello message to the sink node to identify the existence and position of the sink node. The sink node receives the Hello message and then re-transmits the Hello message with respect to all the received Hello messages. Respective middle nodes accumulate distances between the middle nodes while the Hello message is transmitted to the source node through a reverse path of the Hello message, and all the middle nodes maintain a real distance from the sink node. The source node receiving all the Hello messages can rout a plurality of appropriate paths through Hop-by-hop to the sink node by providing respective weights to an energy remaining amount, an appropriate transmission radius and a real distance from the sink node. Accordingly, priorities can be provided to lifetime of the source node, average energy consumption and the shortest path by adjusting the respective weights when routing the plurality of paths. In addition, appropriate paths can be routed considering the transmission success rate of a path, and a load balancing effect can be obtained using path cost.

### TECHNICAL FIELD

The present invention relates to a multi-path routing method for selecting appropriate multiple paths when information sensed from a source node is transmitted to a sink node in wireless sensor networks.

The present invention relates to a routing algorithm considering effective energy consumption of sensor nodes in a wireless sensor network environment, and more particularly, to a network load balancing support routing protocol, wherein multiple paths are formed between sensor and sink nodes to distribute traffic, so that energy can be uniformly used for nodes, and thus, lifetime of the entire network can be increased.

The present invention is derived from a research project supported by the Information Technology (IT) Research & Development (R&D) program of the Ministry of Information and Communication (MIC) and the Institute for Information Technology Advancement (IITA) [2005-S-038-03, Development of UHF RF-ID and Ubiquitous networking technology].

### BACKGROUND ART

The development of communication technologies leads to an environment of information and communication that users can access freely being limited a place, computer or network, which is referred to as ‘ubiquitous’. Studies on communication technologies have been recently developed to apply ubiquitous in real life.

The core technology of the ubiquitous is a wireless sensor network system.

In wireless sensor networks, electronic tags are attached to all required objects, information on ambient environment (temperature, moisture, contamination, crack, etc.) as well as basic recognition information on objects is detected, thereby connecting the detected information in a real time on networks and managing the information.

Ultimately, computing and communication functions are given to all objects to implement an environment where communications can be accomplished anytime, anywhere and anything.

In the wireless sensor network system, a sensing device (node) disposed at a specified or unspecified place senses information such as a geographical, environmental or social change, and transmits the sensed information to another adjacent sensing device or a cluster in which a plurality of sensing devices are grouped in a specified space, or finally transmits the sensed information to a base station.

In a general telecommunication system, data are transmitted/received between a mobile element and a base station. The mobile element and the base station directly transmit/receive without passing through other mobile elements or nodes.

However, when data of a source node is transmitted to a sink node, the wireless sensor network uses other source nodes.

FIG. 1 is a view illustrating the structure of a general wireless sensor network.

The sensor network includes a sink node and a plurality of source nodes. Although only one sink node is illustrated in FIG. 1, the sensor network may include at least two sink nodes depending on a user's setting.

The source node collects information on a target area set by a specified user or a sensor field. The information on the target area collected by the source node is ambient temperature, moisture, movement of an object or outflow of gas.

The source node transmits data of the information collected in the target area to the sink node.

The sink node receives data transmitted by the source nodes constituting the sensor network. Source nodes positioned within a predetermined distance from the sink node directly transmit data to the sink node.

However, source nodes that are not positioned within the predetermined distance from the sink node do not directly transmit collected data to the sink node but transmit the collected data to source nodes adjacent to the sink node.

The sink node is connected to an external network such as Internet, and a user sends a query message to a sensor field through the sink node or receives information collected from the sensor field.

The source node requires microminiaturization, low price and low power. The source node basically includes a microprocessor, an RF transceiver, an AD converter and various sensors.

The sensor network using a plurality of source nodes driven by a battery aims at low energy consumption and low price imputing.

In the sensor network, it is difficult to use the existing IP address system due to energy limit of source nodes and a large number of source nodes.

While routing is an address-oriented method in a conventional wire/wireless network, routing is a data-oriented method in the sensor network.

Routing protocols in the sensor network are classified into a proactive routing protocol and a reactive routing protocol depending on a method of obtaining root information.

In the proactive routing protocol, source nodes periodically turn on sensors and switches of transmitters to monitor an environment, and transmit data belonging to interest. Thus, since the state of the sensor network can be monitored at a periodic interval, the proactive routing protocol is suitable for applications requiring periodic data monitoring.

In the reactive routing protocol, source nodes continuously sense an environment to immediately react to an abrupt change of a sensed attribute value. Thus, the reactive routing protocol is suitable for intrusion detection, explosion detection or time critical applications.

In addition, routing protocols are classified into a flat routing protocol and a hierarchical routing protocol depending on a topology structure of the wireless sensor network.

In the flat routing protocol, since the entire network is considered as one area, all nodes can equally participate in routing, and multi-hop routing is provided.

In the hierarchical routing protocol, routing is performed by dividing a network into a plurality of areas based on clustering and providing a head function to a specific node in each of the areas.

### DISCLOSURE OF INVENTION

### Technical Problem

The directed diffusion (DD) routing protocol is a representative reactive routing protocol based on flooding, and includes four steps of interest, gradient, data transmission and reinforcement.

In the DD routing protocol, since it is assumed that each source node does not have a global unique identifier, the node identify only its own neighboring nodes, and a packet for transmitted task or detected information is stored in a cache of the node.

A sink node describes a task that the sink node desires to monitor and distributes the task to the entire network. At this time, the task may be distributed through flooding or using a more (implicated method than the flooding.

A source node receiving the task identifies whether or not the source node should perform the task and then transmits the task to a neighboring node again. An initial gradient is set to a neighboring node that transmitted the task to the source node for the first time.

Alternatively, the gradient is set to a neighboring node having the highest energy.

When an event corresponding to the task occurs, the source node transmits data to the neighboring node to which the gradient is set.

At this time, data may be transmitted to the sink node through multiple paths.

The sink node receiving the data reinforces the gradient of one path or the gradients of some of the multiple paths through various references.

After that, excellent paths among the initial paths are used, and therefore, network lifetime may be lowered. In addition, fine energy for maintaining a gradient may be continuously consumed.

The energy aware routing (EAR) protocol is a routing protocol for maximizing network lifetime in an energy-limited sensor network.

The conventional sensor network routing protocols selected a path in which the minimum energy is used, and minimized energy consumption using the selected path.

However, since the optimal path is continuously used in selecting a path selection and using the selected path, energy is intensively consumed at nodes on the optimal path.

The EAR protocol is a scheme of balancing energy consumption by maintaining multiple paths rather than the optimal path in order to solve an energy consumption problem and randomly selecting a path based a constant probability.

However, since a transmission reference table is not renewed while transmitting sensed information, adaptability for a change in energy state of a node is lowered, and therefore, the energy state may not be effectively influenced.

In the energy-efficient multi-path routing protocol (EEMRP), multiple paths in which nodes are not overlapped with each other are searched between source and sink nodes, the sink node allocates a transmission rate to the source node considering path cost, thereby obtaining a load balancing effect.

The path cost is determined by an energy state and the number of hops, and traffic is balanced over several paths through load balancing. The lifetime of the entire network is increased through the traffic balancing.

The EEMRP passes through three steps of initialization, path search, and data transmission and maintenance to search multiple paths.

In the initialization step, source nodes collect energy levels of neighboring nodes and information on a sink node while receiving/transmitting a Hello message from/to the neighboring nodes. When the Hello message is received, each of the source nodes renews a neighboring node table.

The sink node broadcasts the Hello message again. In the path search step, the source node transmits a query message to the sink node, and a node with the lowest link cost is selected as the next node.

In data transmission and maintenance step, the sink node searches multiple paths in the source nodes, and then allocates a transmission rate to each of the multiple paths using a fairness index for the purpose of load balancing.

However, an energy index considered in a cost index is simply a ratio of an initial amount and a remaining amount, and an index for the distance from the sink node does not consider a distance between nodes but simply applies the number of hops. Moreover, only delay time is considered without considering transmission success rate, and therefore, transmission reliability may be lowered.

### Technical Solution

The present invention provides a method capable of considering lifetime of source nodes, average energy consumption and the shortest path by simultaneously reflecting an energy remaining amount, an appropriate transmission radius and a real distance from a sink node in wireless sensor networks, and a load balancing scheme.

### Advantageous Effects

When information sensed from a source node is transmitted to a sink node in wireless sensor networks, multiple paths are searched by providing respective weights to an energy remaining amount, an appropriate transmission radius and a real distance from the sink node, and appropriate multiple paths are then selected. In addition, a load balancing effect can be obtained by applying a path coast function.

### DESCRIPTION OF DRAWINGS

The above and other features and advantages of the present invention will become more apparent by describing in detail exemplary embodiments thereof with reference to the attached drawings in which:

FIG. 1 is a view illustrating the structure of a general wireless sensor network;

FIG. 2 is a view illustrating a Hello message in an initialization step according to an embodiment of the present invention;

FIG. 3 is a view illustrating a result obtained when a source node floods the entire sensor network with a Hello message in the initialization step according to the embodiment of the present invention;

FIG. 4 is a view illustrating a result obtained when a sink node floods source nodes with a Hello message in response of the Hello message received from the source node according to the embodiment of the present invention;

FIG. 5 is a graph illustrating log function y=−log x (base is e);

FIG. 6 is a view showing data transmission through path P(n₀,nₖ) between n₀ and nₖ;

FIG. 7 is a view illustrating a Request message format transmitted from the source node to a neighboring node selected by providing respective weights to an energy remaining amount, an appropriate transmission radius and a real distance from the sink node according to the embodiment of the present invention;

FIG. 8 is a view illustrating multi-path routing when w₂=1 in Equation 8 in which a path is selected by providing respective weights to the energy remaining amount, the appropriate transmission radius and the real distance from the sink node according to the embodiment of the present invention;

FIG. 9 is a view illustrating multi-path routing when w₃=1 in Equation 8 in which a path is selected by providing respective weights to the energy remaining amount, the appropriate transmission radius and the real distance from the sink node according to the embodiment of the present invention; and

FIG. 10 is a view illustrating path Pₖ between n₀ and nₖ by a multi-path routing method according to an embodiment of the present invention.

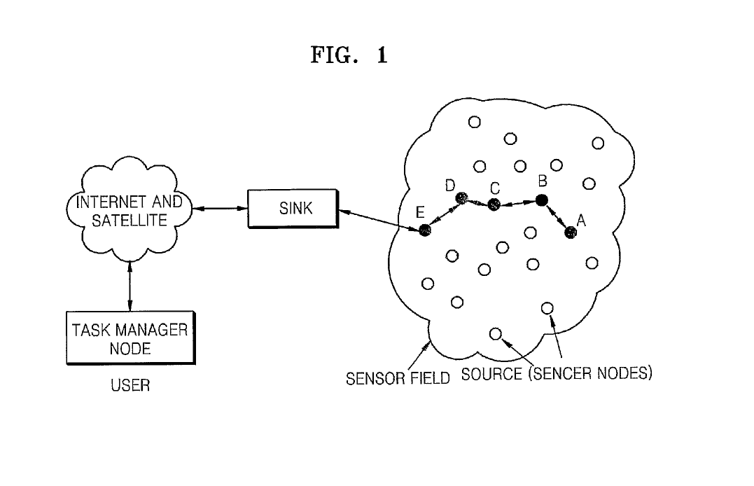

### BEST MODE

According to an aspect of the present invention, there is provided a multi-path routing method in wireless sensor networks. The multi-path routing method includes: a first source node collecting a sensing event in a sensing area and selecting an one source node having the smallest result value added by providing respective weights to a current energy remaining amount of any one of the plurality of second source nodes positioned in the sensing area, a transmission radius of the first source node and a real distance from a sink node receiving the sensing event from the first source node among the second source nodes; the selected source node selecting another one of the second source nodes except the selected source node using the same method as the first node, and routing a plurality of paths that are not overlapped with one another between the first source node and the sink node by repeating the source node selecting process, the plurality of paths not being overlapped with one another and having at least one of the second source nodes; and the sink node receiving the sensing event of the first source node through the plurality of paths.

According to another aspect of the present invention, there is provided a wireless sensor network. The wireless sensor network includes: a first source node for collecting a sensing event in a sensing area; and a plurality of second source nodes for participating in a plurality of paths routed by providing respective weights to a current energy remaining amount of any one of the plurality of nodes in the sensing area, a transmission radius of the first source node and a real distance from the sink node receiving the sensing event, and transmitting the sensing event from the first source node to the sink node through the plurality of paths.

### Mode for Invention

In the following detailed description, reference is made to the accompanying drawings that show, by way of illustration, specific embodiments in which the present invention may be practiced. These embodiments are described in sufficient detail to enable those skilled in the art to practice the present invention.

The suggested algorithm includes three steps of initialization, path search, and data transmission and maintenance.

Each node identifies its own energy level and a node loss probability, and all neighboring nodes within a transmission radius exchange and share such information with one another.

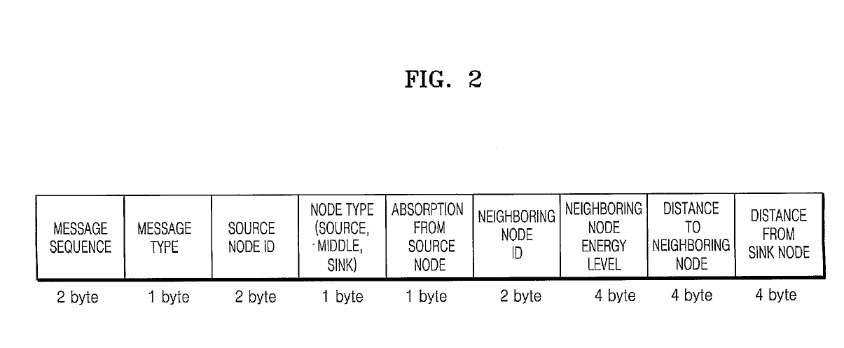

The first step is an initialization step. In the initialization step, when a source node senses information, the source node floods the entire network with a Hello message to obtain information on the existence and position of a sink node. The format of the Hello message is illustrated in FIG. 2.

As illustrated in FIG. 2, the Hello message in the initialization step according to an embodiment of the present invention includes not only the energy level of a neighboring node and the number of hops from the source node to the sink node but also the distance information (4 bytes) to the neighboring node and the distance information (4 bytes) from the sink node.

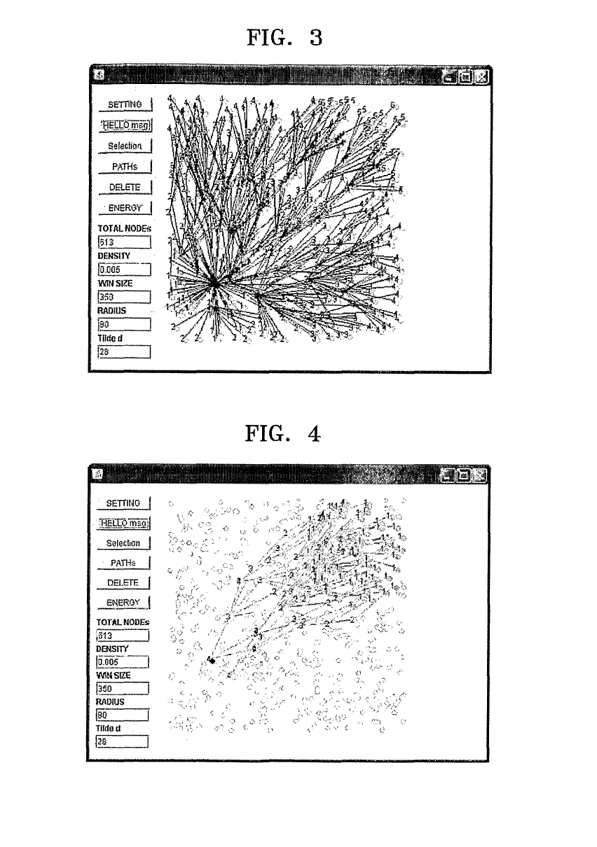

FIG. 3 is a view illustrating a result obtained when a source node floods the entire sensor network with a Hello message in the initialization step according to the embodiment of the present invention.

If the Hello message reaches the sink node, the sink node floods the entire sensor network with the Hello message to reach the source node, referring to field ‘the number of hops’ and field ‘neighboring node ID’.

A plurality of sink nodes may be provided depending on the structure of the sensor network.

FIG. 4 is a view illustrating a result obtained when a sink node floods source nodes with a Hello message in response of the Hello message received from the source node according to the embodiment of the present invention.

When finishing transmission/reception of Hello messages between the source and sink nodes and re-transmission/re-reception of Hello messages between the source and sink nodes, all nodes in the sensor network can share information of a neighboring node (an energy remaining amount, a distance to the sink node, a distance to the neighboring node and the like).

The second step is a path search step.

When selecting a path, indicator f considered when selecting a neighboring node is obtained by calculating fₑ, fᵢ and f_{d} respectively reflecting an energy remaining amount, an appropriate transmission radius and a real distance from the sink node, and combining them for each weight.

Applying Energy Remaining Amount

Each of the source nodes recognizes its initial energy eᵢₙᵢ and its current remaining energy eᵣₑₛ.

$$\begin{matrix}[ Math . 1 ] & \\ {f}_{e} = min \{ 1 , - {log}_{10} \frac{{e}_{res}}{{e}_{ini}} \} & ( 1 )\end{matrix}$$

Here, fₑ is an energy remaining amount of a neighboring source node, eᵢₙᵢ is an initial energy of a source node itself, and eᵣₑₛ is a current remaining energy of the source node itself.

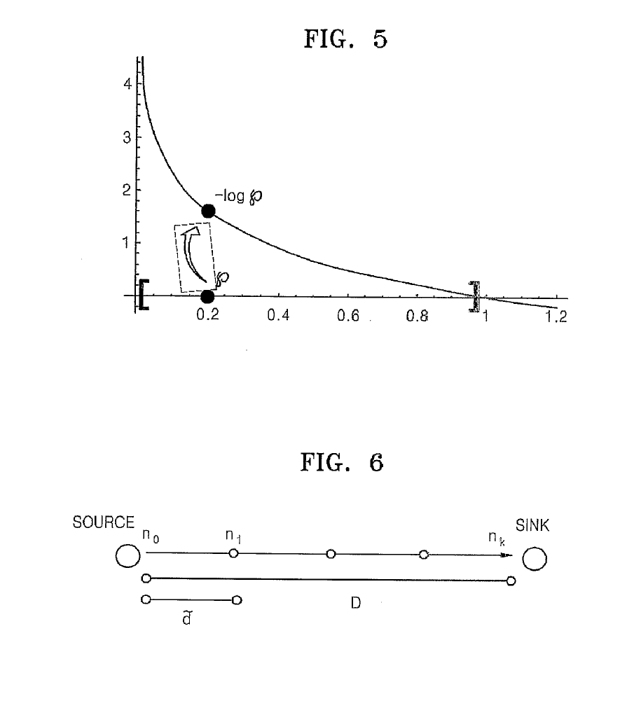

FIG. 5 is a graph illustrating log function y=−log x (base is e).

In the multi-path routing method according to the embodiment of the present invention, a path is determined using a method of selecting a node at which value f (Equation 8) considering the three indicators of fₑ, fᵢ and f_{d} respectively reflecting the energy remaining amount, the appropriate transmission radius and the real distance from the sink node is the minimum.

As illustrated in Equation 1, fₑ is obtained by considering the energy remaining amount of a node. When the energy remaining amount is small because of properties of the log function, ‘1’ rather than the energy remaining amount of the node is selected as fₑ.

When the energy remaining amount is small, the total value of f is arbitrarily applied depending on a given weight on the basis of Equation 8. For this reason, a corresponding node is randomly selected.

As illustrated in FIG. 5, when the energy remaining amount is small, the probability of selection of the node can be rapidly decreased because of properties of the log function.

In addition, the energy remaining amount was considered up to 10% by using the base of the log function as ‘10’. After that, the energy remaining amount was selected as ‘1’ such that the corresponding node was randomly selected.

Applying Appropriate Transmission Radius

A method of reflecting a transmission radius when selecting a path according to the embodiment of the present invention uses an energy model as follows.

$$\begin{matrix}[ Math . 2 ] & \\ \frac{1}{{C}_{1}} \text{:} \frac{1}{{C}_{2}} \text{:} … \text{:} \frac{1}{{C}_{Nmax}} & ( 2 )\end{matrix}$$

Here, Eₜₓ is energy consumed when transmitting a 1-bit data with respect to distance ‘d’, α₁₁ is energy consumed per bit when a transmitter transmits data, and α₂ is energy consumed per bit when an operational amplifier (op-amp) transmits data.

Since Eₜₓ is exponentially increased depending on a distance, it may be effective to transmit data via a plurality of nodes.

However, if the number of middle node through which data are transmitted is too large, more energy will be consumed as compared with a method of transmitting data at a time. Therefore, an appropriate distance between the middle nodes is important to effectively transmit data.

[Math.3]

Eᵣₓ=α₁₂ (3)

Here, Eᵣₓ is energy consumed when receiving a 1-bit data with respect to distance ‘d’, and α₁₂ is energy consumed per bit when a receiver receives data.

As described in Equation 3, the energy consumed in data reception is constant unlike in data transmission.

FIG. 6 is a view showing data transmission through path P(n₀,nₖ) between n₀ and nₖ.

Energy consumption E(P(n₀,nₖ)) through a middle node in data transmission is as follows.

[Math.4]

F=w₁fₑ+w₂fᵢ+w₃f_{d} (4)

Here, E(P(n₀,nₖ)) is energy consumption through the middle node in data transmission from source node n₀ to sink node nₖ.

At this time, it is assumed that the ideal distance of the middle node is defined as

‘\tilde{d}’. [Math.5]

The number of optimal middle nodes in accordance with

‘\tilde{d}’ [Math.6]

is

└D/\tilde{d}┘. [Math.7]

Thus, the energy consumption between the source node n₀ and the sink node nₖ.

$$\begin{matrix}[ Math . 8 ] & \\ \begin{matrix}E ( P ( {n}_{0} , {n}_{K} ) ) = {\sum }_{r = 1}^{⌊ D / \tilde{d} ⌋} E ( P ( {n}_{r - 1} , {n}_{r} ) ) \\ = \frac{D}{\tilde{d}} ( {α}_{11} + {α}_{2} {\tilde{d}}^{n} )\end{matrix} & ( 5 )\end{matrix}$$

Here, E(P(n₀,nₖ)) is energy consumption through the middle node in data transmission from the source node n₀ to the sink node nₖ,

└D/\tilde{d}┘ [Math.9]

is the number of optimal middle nodes, α₁₁ is energy consumed per bit when a transmitter transmits data, and α₂ is energy consumed per bit when an op-amp transmits data.

In Equation 5, the energy consumption is the minimum when the energy consumption has the minimum value in data transmission.

Thus,

$$\frac{\partial }{\partial \tilde{d}} E ( P ( {n}_{0} , {n}_{k} ) ) = 0. \qquad [ Math . 10 ]$$

At this time,

$$\tilde{d} = \sqrt[n]{\frac{{α}_{1}}{{α}_{2} ( n - 1 )}} . \qquad [ Math . 11 ]$$

In the algorithm according to the embodiment of the present invention, the next hop node is selected using

‘\tilde{d}’. [Math. 12]

As an approximate degree to

‘\tilde{d}’ [Math. 13]

is increased, the selected probability can be increased.

Thus, the suggested indicator fᵢ is as follows. Here, ‘d’ is a distance to a neighboring node.

[Math.14]

fᵢ=min{1,|\tilde{d}−d|/\tilde{d}} (6)

Here, fᵢ is an optimal transmission radius,

\tilde{d} [Math.15]

is a distance to an ideal neighboring node with the minimum energy consumption, and d is a distance to a neighboring node.

Applying Real Distance from Sink Node

An optimal node can be selected by comparing the distance when using the next hop with the current remaining distance using field (4 bytes) ‘distance from sink node’ in the Hello message.

If the current node, neighboring node and sink node are respectively ‘x’, ‘y’ and ‘z’, it is assumed that the distances from the current node to the sink node and from the neighboring node to the sink node are respectively d(x,z) and d(y,z). If the value of d(x,z)−d(y,z) is not a positive number, it is assumed that f_{d} is ‘1’. Otherwise, it is assumed that a priority is provided to the node with a high value of

$$\frac{d ( x , z ) - d ( y , z )}{d ( x , z )} \qquad [ Math . 16 ]$$

Thus, f_{d} is defined as follows.

$${f}_{d} = \{ \begin{matrix}1 - \frac{d ( x , z ) - d ( y , z )}{d ( x , z )} = \frac{d ( y , z )}{d ( x , z )} & if d ( x , z ) - d ( y , z ) > 0 \\ 1 & if otherwise\end{matrix} \qquad ( 7 )$$

Here, f_{d} is an indicator for selecting a neighboring node by reflecting a real distance to the sink node.

The three indicators of fₑ, fᵢ and f_{d} are used when selecting the next node by combining them for each weight.

[Math. 17]

F=wᵢfₑ+w₂fᵢ+w₃f_{d} (8)

Here, w₁, w₂ and w₃ are weights, and the respective weights satisfy the relation of

$${\sum }_{i = 1}^{3} {w}_{i} = 1 \qquad [ Math . 18 ]$$

Thus, the source node selects a neighboring node with the minimum value of the indicator f and transmits a Request message to the selected neighboring node.

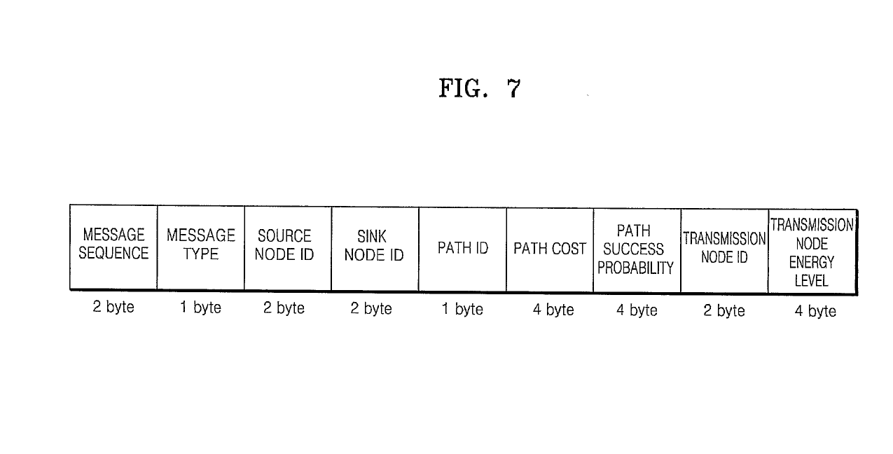

At this time, the message format is illustrated in FIG. 7.

FIG. 7 is a view illustrating a Request message format transmitted from the source node n₀ to a neighboring node n₁ selected by providing respective weights to an energy remaining amount, an appropriate transmission radius and a real distance from the sink node according to the embodiment of the present invention.

The neighboring node n₁ receiving the Request message renews the state information of its own neighboring nodes n₂ and calculates values f of its own neighboring nodes to transmit the renewed state information to a node with the minimum value among the values.

That is, the node n₁ transmits a Request message to a neighboring node to renew the sate information of the neighboring node of the node n₁ and to select the appropriate node as the same manner in which the source node n₀ transmits a Request message to the neighboring node n₁ by providing respective weights to the energy remaining amount of the neighboring node n₁, its own appropriate transmission radius and its own real distance from the sink node so as to identify the state of the neighboring node and to select the appropriate node n₁.

In field (4 bytes) ‘path cost’, values of f are continuously accumulated.

The node selected once is not selected again to set a node-disjoint path.

The value off is multiplied by Its own success probability (1−loss probability) and stored in field (4 bytes) ‘path success probability.

The initial setup value is ‘1’, and if the Request message finally reach the sink node, the transmission success probability of Pᵢ.

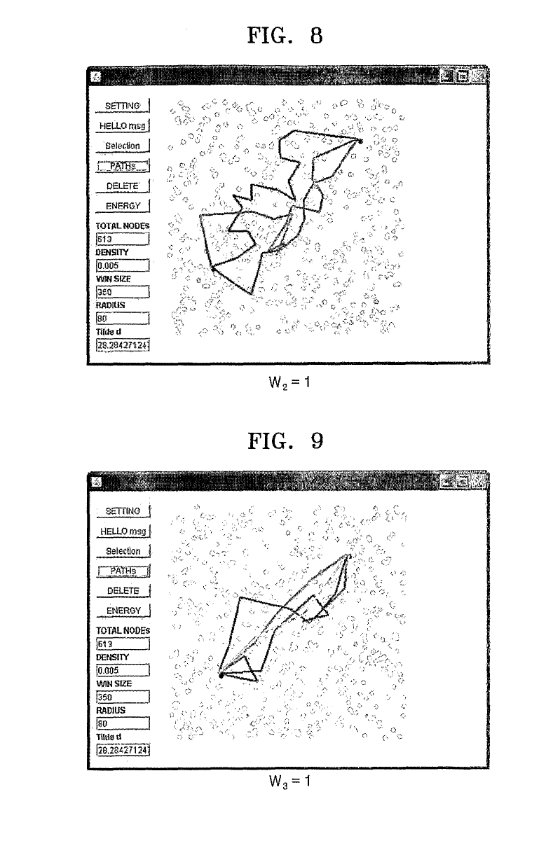

FIG. 8 is a view illustrating multi-path routing when w₂=1 in Equation 8 in which a path is selected by providing respective weights to the energy remaining amount, the appropriate transmission radius and the real distance from the sink node according to the embodiment of the present invention.

FIG. 9 is a view illustrating multi-path routing when w₃=1 in Equation 8 in which a path is selected by providing respective weights to the energy remaining amount, the appropriate transmission radius and the real distance from the sink node according to the embodiment of the present invention.

Since a neighboring node is searched considering a radius at which energy is less consumed on the average when w₂=1, multiple paths are broadly extended. However, since a real distance is considered when w₃=1, all paths are gathered in the middle.

The third step is a data transmission and maintenance step.

The sink node identifies the received Request message and obtains k paths P₁, P₂, . . . , Pₖ.

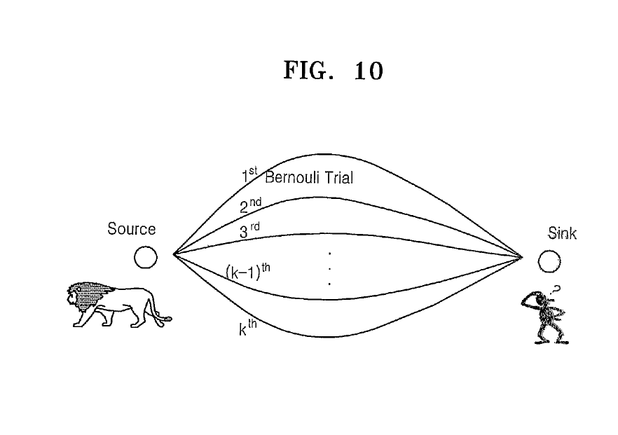

FIG. 10 is a view illustrating path Pₖ between n₀ and nₖ by a multi-path routing method according to an embodiment of the present invention. As illustrated in FIG. 10, respective multiple paths are not overlapped with one another.

Thus, transmission success probability Pᵢ is independent.

The average number of paths through which transmission is succeeded among k paths obtained by applying the Bernoulli trial is

$${\sum }_{i = 1}^{k} {P}_{i} . \qquad [ Math . 19 ]$$

This is used as maximum value of possible paths Nmax

$$\begin{matrix}[ Math . 20 ] & \\ {N}_{max} = ⌈ {\sum }_{i = 1}^{k} {P}_{i} ⌉ & ( 9 )\end{matrix}$$

Thus,

P*₁, P*₂, . . . , P*ₖ [Math. 21]

are selected considering an order of paths with high probability among pats P₁, P₂, . . . , Pₖ.

In view of load balancing, traffic is balanced at a rate of reciprocal of path cost Cᵢ stored in the field as illustrated in FIG. 10.

$$\begin{matrix}[ Math . 22 ] & \\ \frac{1}{{C}_{1}} \text{:} \frac{1}{{C}_{2}} \text{:} … \text{:} \frac{1}{{C}_{Nmax}} & ( 10 )\end{matrix}$$

The sink node transmits the rate to the source node through an Ack message.

In embodiments of the present invention, recording media read through a computer can be implemented with codes read by the computer. The recording media read through the computer include all types of recording devices in which data read by a computer system are stored.

For example, the recording media read by the computer includes ROMs, RAMs, CD-ROMs, magnetic tapes, floppy disks, optical data storage devices and the like. In addition, the recording media is implemented in the form of carrier waves (e.g., transmission through Internet). The recording media read by the computer can be balanced in the computer system connected through networks, and codes read by the computer can be stored and executed using a balancing method.

As described above, preferred embodiments of the present invention has been described.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A multi-path routing method in wireless sensor networks, comprising:
a first source node collecting a sensing event in a sensing area and selecting an one source node having the smallest result value added by providing respective weights to a current energy remaining amount of any one of the plurality of second source nodes positioned in the sensing area, a transmission radius of the first source node and a real distance from a sink node receiving the sensing event from the first source node among the second source nodes;
the selected source node selecting another one of the second source nodes except the selected source node using the same method as the first node, and routing a plurality of paths that are not overlapped with one another between the first source node and the sink node by repeating the source node selecting process, the plurality of paths not being overlapped with one another and having at least one of the second source nodes; and
the sink node receiving the sensing event of the first source node through the plurality of paths.

2. The multi-path routing method of claim 1, further comprising:
the first source node flooding the second source node with a call message to identify the position of the sink node; and
the sink node receiving the call message and flooding the second source node with a response message to transmit the response message to the first node.

3. The multi-path routing method of claim 1, wherein at least one of the first source node, sink node and second source node constituting the multiple paths transmits or receives a Request message having information on its own ID and path ID, path cost, path success probability, transmission node energy level and the like when routing the plurality of paths.

4. The multi-path routing method of claim 1, wherein the sum of weights respectively provided to the current energy remaining amount of the source node, the transmission radius and the real distance from the sink node receiving the sensing event is ‘1’ when routing the plurality of paths.

5. The multi-path routing method of claim 1, wherein a plurality of sink nodes receive the sensing event.

6. The multi-path routing method of claim 2, wherein the call message contains information on the ID of the first source node, the ID of the second source node ID, the number of hops from the first source node, the distance from the sink node and the energy levels of the first and second source nodes.

7. The multi-path routing method of claim 3, wherein the priority of traffic transmission rates in the respective paths is determined by the path success probability, and the traffic transmission rates are balanced to be in proportion to a reciprocal of the path cost in the receiving of the sensing event.

8. The multi-path routing method of claim 6, wherein the response message is flooded based on the number of hops in the call message and the IDs of the first and second source nodes.

9. A wireless sensor network, comprising:
a first source node for collecting a sensing event in a sensing area; and
a plurality of second source nodes for participating in a plurality of paths routed by providing respective weights to a current energy remaining amount of any one of the plurality of nodes in the sensing area, a transmission radius of the first source node and a real distance from the sink node receiving the sensing event, and transmitting the sensing event from the first source node to the sink node through the plurality of paths.

10. The wireless sensor network of claim 9, wherein the sum of the weights is ‘1’.

11. The wireless sensor network of claim 9, wherein a plurality of sink nodes receive the sensing event.

12. The wireless sensor network of claim 9, wherein at least one of the first source node, sink node and second source node constituting the multiple paths transmits or receives a Request message having information on its own ID and path ID, path cost, path success probability, transmission node energy level and the like when routing the plurality of paths.

13. The wireless sensor network of claim 9, wherein the routing of the plurality of paths comprises:
the first source node selecting an one source node having the smallest result value added by providing respective weights to a current energy remaining amount of any one of the plurality of second source nodes positioned in the sensing area, a transmission radius of the first source node and a real distance from a sink node receiving the sensing event from the first source node among the second source nodes positioned in the sensing area; and
the selected source node selecting another one of the second source nodes except the selected source node using the same method as the first node, and routing a plurality of paths that are not overlapped with one another between the first source node and the sink node by repeating the source node selecting process, the plurality of paths not being overlapped with one another and having at least one of the second source nodes.

14. The wireless sensor network of claim 9, wherein the position identification of the sink node comprises:
the first source node flooding the second source node with a call message to identify the position of the sink node; and
the sink node receiving the call message flooding the second source node with a response message to transmit the response message to the first node.

15. The wireless sensor network of claim 12, wherein the priority of traffic transmission rates in the plurality of paths is determined by the path success probability, and the traffic transmission rates are balanced to be in proportion to a reciprocal of the path cost in the receiving of the sensing event.

16. The wireless sensor network of claim 14, wherein the call message contains information on the ID of the first source node, the ID of the second source node ID, the number of hops from the first source node, the distance from the sink node and the energy levels of the first and second source nodes.

17. The wireless sensor network of claim 14, wherein the response message is flooded based on the number of hops in the call message and the IDs of the first and second source nodes.
